(19) United States
(12) Patent Application Publication
(10) Pub. No.: US 2016/0154489 A1
(43) Pub. Date: Jun. 2, 2016

(54) TOUCH SENSITIVE EDGE INPUT DEVICE FOR COMPUTING DEVICES

(71) Applicants: Antonio R. Collins, Saint Petersburg, FL (US); Esther R. Sailo, Gulfport, FL (US)

(72) Inventors: Antonio R. Collins, Saint Petersburg, FL (US); Esther R. Sailo, Gulfport, FL (US)

(21) Appl. No.: 14/555,667

(22) Filed: Nov. 27, 2014

(51) Int. Cl. G06F 3/041; G06F 3/01

(52) U.S. Cl. CPC G06F 3/041; G06F 3/017; G06F 2203/04104

(57) ABSTRACT

A narrow strip for use in conjunction with a computing device which enables touch sensitive edge functionality in response to fingers in contact with the strip. The edge strip allows a user to control aspects of the computing device by using various touches and gestures without occluding the face of the computing device.

### CROSS-REFERENCE TO RELATED APPLICATIONS

Not Applicable

### TECHNICAL FIELD

This relates generally to electronic devices with touch-sensitive surfaces, including but not limited to smartphones, computing tablets, and laptops.

### BACKGROUND OF THE INVENTION

As touchscreen electronic devices have proliferated, several shortcomings of the touchscreen interface have become apparent.
1) The act of touching the screen hides the display element which the user is interacting with. This leads to erroneous input and causes user frustration with the device.
2) Small, high-resolution touchscreen devices cause touches to be less precise and contribute to more frustration from users with large fingers.

Touchscreen interface designers have attempted to address these shortcomings using haptic feedback (vibration in response to a touch), aural feedback (a sound in response to a touch), visual “touchprints” (a glow to indicate what was touched), visual cues (a popup with additional choices), styluses (pens for better precision), special function zones (such as the notification area on a smartphone), multi-finger gestures (two finger swipes, pinch to zoom, etc.), and input styluses.

These alternate feedback and input techniques generate a more confusing user interface and often contribute to additional user frustration with the device.

### BRIEF SUMMARY OF THE INVENTION

When mounted on the edge of a device, a touch sensitive strip can overcome many of the inherent touchscreen shortcomings and provide a better interaction experience than a touchscreen alone. Most significantly, it allows the user to interact with a touch device without obscuring onscreen content. Content can be easily moved, scaled, and dismissed by using the touch strip with no interaction on the touchscreen needed.

In a typical embodiment, edge touches can be combined to create far more intuitive gestures than a touchscreen alone. These gestures can be customized and assigned to various functions by the user. A custom unlock gesture can be more secure than a PIN and leaves no telltale fingerprint nor swipe trail behind. Edge gestures can provide advanced controls for gaming and other applications which are hamstrung by touchscreen limitations.

In another embodiment, edge gestures can be independent of onscreen content. Two double-taps on the top can snap a photo even if in a call. A bottom slide can switch between open applications.

In another embodiment, a device equipped with a touch sensitive edge need not have physical buttons. A “tickle” on the bottom edge can wake it. Rolling a finger over a top corner can adjust volume. Pinching a bottom corner can turn the device off.

In this embodiment, a button free device can also be activated regardless of its orientation. When coupled with wireless charging and wireless data technologies, a button free device can be made as waterproof as a diver's watch and retain full edge touch capabilities underwater.

In another embodiment, edge touch capability can be added to non-touchscreen devices such as televisions or remote controls. As with a smartphone, the controlled device's volume can be adjusted with a corner roll, its channel changed with a slide, and the device can be powered off with a pinch.

### BRIEF DESCRIPTION OF THE DRAWINGS (12)

Various drawings are provided to better describe the mounting and use of the touch sensitive strip with various devices. No drawings are to scale.

FIG. 1: Illustrates a prototypical touch sensitive strip with each rectangle representing a touch sensitive point on the strip.

FIG. 2: Illustrate a flexible implementation of a touch sensitive strip.

FIG. 3: Illustrates a device equipped with 4 non-contiguous touch sensitive strips. The hardware controller can aggregate touch activity from two or more strips to simulate a single contiguous strip.

FIG. 4: Illustrates a device with a single touch sensitive strip wrapping around the corners of the device.

FIG. 5: Illustrates a finger performing a flick gesture on a typical device with the touch sensitive strip being interrupted by physical buttons and I/O ports. The hardware controller can aggregate touch activity from the longer segment with the shorter segment to simulate a single segment.

FIG. 6: Illustrates fingers performing an expansion gesture on the logical side of a device in horizontal orientation.

FIG. 7: Illustrates a flexible touch sensitive strip mounted on a round watch face. Fingers are performing a twist gesture on the edge on the watch.

FIG. 8: Illustrates a finger performing a simple flick gesture on the logical bottom of a device in vertical orientation. “X”s indicate mass touches which are ignored.

FIG. 9: Illustrates a touch sensitive strip wrapped around a remote control. Touch activity on the remote performs functions on its associated television.

FIG. 10: Illustrates fingers performing an expansion gesture on a large device equipped with a single touch sensitive strip which spans the right side and lower right corner of the device.

FIG. 11: Illustrates two fingers performing a multi-press gesture activating a camera shutter on a small handheld device. “X”s indicate extraneous touches which are ignored.

FIG. 12: Illustrates two fingers performing a contraction gesture which turn off the display of a small handheld device.

### DETAILED DESCRIPTION OF THE INVENTION

The invention includes a strip utilizing resistive or capacitive technologies to detect touches from human fingers on the strip's lengthwise axis. The strip is depicted in FIG. 1 as a ladder with each rung of the ladder representing a touch sensitive location. The strip may be rigid or flexible and when flexible can wrap around the contours of various devices.

When mounted on a device with suitable in-built computing capabilities (FIG. 5, 6, 7, 8, 9), the invention includes a hardware controller which translates touches into absolute and relative coordinates on the strip. The hardware controller also aggregates touches to distinguish between single touches, multiple concurrent touches, touches with movement, and touches from multiple strips (FIG. 5, 6, 11, 12).

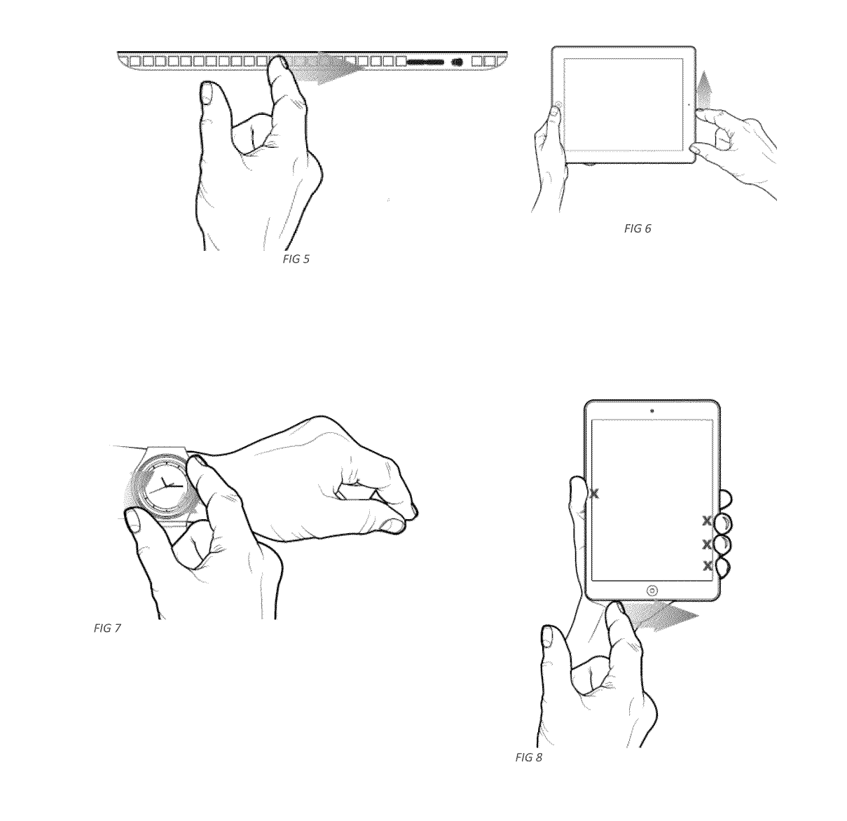

The invention includes firmware for the controller to convert touch activity into input directives for the host computing device. The firmware can modify touch activity to accommodate the physical shape of the mounted device and can ignore certain touch activity (FIG. 7, 8). The firmware can interface with other hardware controllers to modify touch activity based on other activity on the controlled device such as orientation changes or active software applications.

The hardware controller will present the following exemplary touches and gestures to the host operating system/applications.
a. Detection of a single point of contact with continuous contact for a minimum time period. This interaction is considered a touch.
b. Simultaneous touches within a minimum time period. This interaction is considered a multi-touch.
c. A touch with continuous contact for a minimum time period. This interaction is considered a press.
d. Simultaneous touches with continuous contact on all contact points for a minimum time period. This interaction is considered a multi-press.
e. A press followed by one or more touches within the duration of the first press. This interaction is considered a chord.
f. A touch followed by a back and forth motion. This gesture indicates a tickle.
g. A touch followed by continuous contact in a single direction. This gesture indicates a flick.
h. A flick ended with a continuous touch for a minimum time period at the end point. This gesture indicates a slide.
i. A slide which spans a geometric vertex or curve. This gesture indicates a roll.
j. A slide immediately followed by an additional slide with continuous contact between each slide. This gesture indicates an adjustment.
k. Two slides starting at a minimum distance from each other so as to be considered non-adjacent and ending within a minimum distance of the other so as to be considered adjacent. This gesture indicates a contraction.
l. Two slides starting within a minimum distance so as to be considered adjacent and ending beyond a minimum distance of the other so as to be considered non-adjacent. This gesture indicates an expansion.
m. Two slides starting at opposing sides or hemispheres of a device and moving in the same direction. This gesture indicates a shove.
n. Two slides starting at opposing sides or hemispheres of a device and moving in opposite directions. This gesture indicates a twist.

Additional touches and gestures may be defined to accommodate devices with unusual shapes, users with special needs, and other usage patterns and environments.

Touches will include additional data to describe where the touch took place. Gestures will include the data of one or more touches and will include additional data to describe the direction, duration, and speed of touch movement.

1. A touch sensitive strip which can detect and locate human or similar touches when coupled with a hardware controller on a physical device with suitable in-built computing hardware. (FIG. 1).

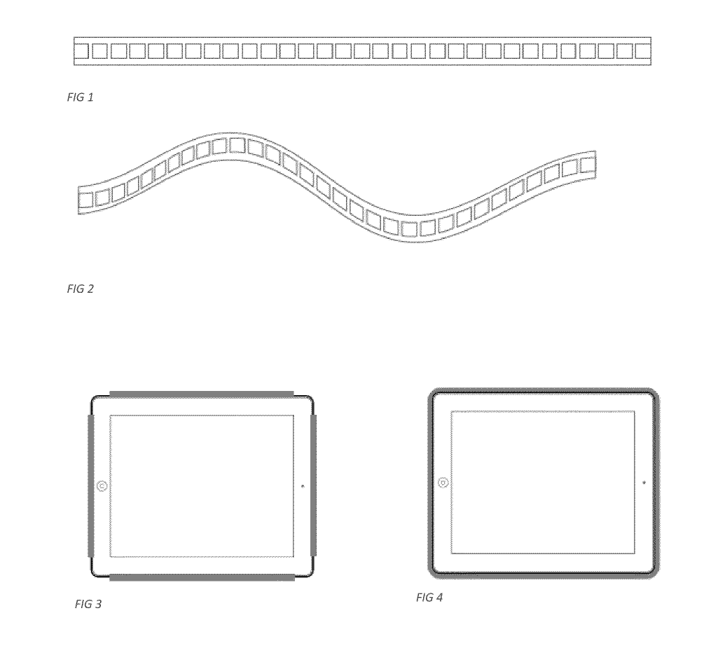

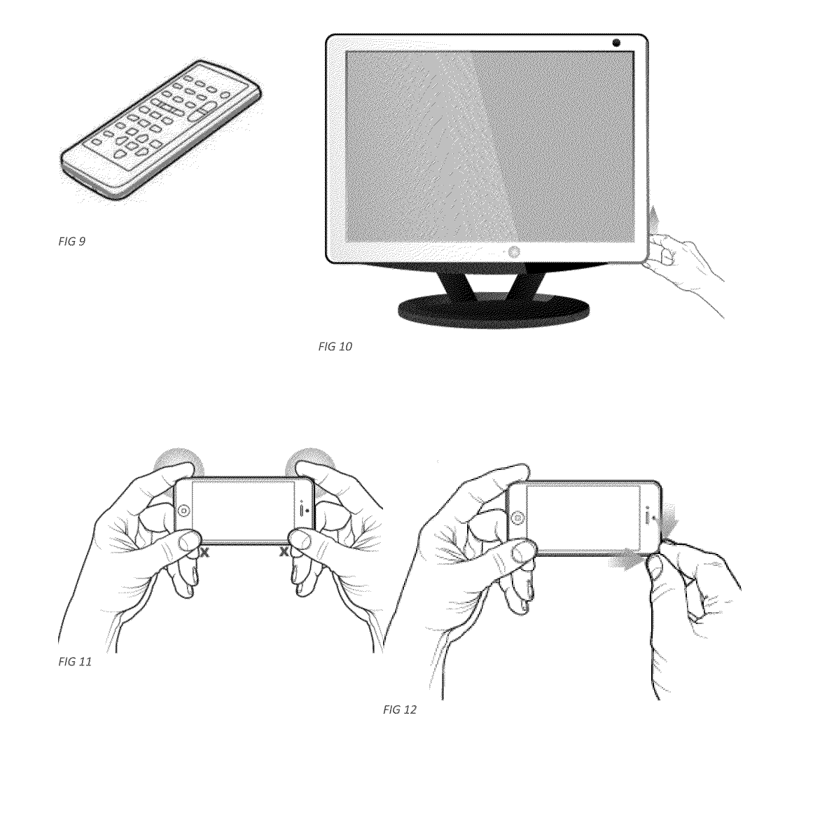

2. The touch sensitive strip of claim 1 is flexible (FIG. 2) and capable of being mounted on a single edge (FIG. 3) or wrapping around multiple edges (FIG. 4) of an associated physical device with suitable in-built computing hardware. Examples of such devices include but are not limited to: watches (FIG. 7), smartphones (FIG. 11), hand held computers, computing tablets (FIG. 6), laptop computers, display monitors, televisions (FIG. 10), and remote controls (FIG. 9).

3. The touch sensitive strip of claim 1 interfaces with a hardware controller which translates touches into absolute and relative coordinates.

4. The absolute coordinates of claim 3 can be mapped to the shape of the physical device to which the touch sensitive strip of claim 1 is attached. This mapping supports rectangular (FIG. 6), round (FIG. 7), and irregular shaped devices and accommodates physical interruptions of a strip (FIG. 5).

5. The absolute coordinates of claim 3 can be translated to relative coordinates mapped to logical named segments of the physical shape (such as “top”, “left side”, “bottom middle”, “upper right quadrant”, etc.).

6. The hardware controller of claim 3 can identify various touch activity including a single touch (FIG. 8), simultaneous touches (FIG. 11), duration and intervals between touches, and the direction of movement of any touch (FIG. 12).

7. The hardware controller of claim 3 can identify touch activity from two or more touch sensitive strips and aggregate the touch activity so as to represent a single virtual strip.

8. The hardware controller of claim 3 implements low-power technology to remain active even when the associated device to which it is attached is in a deep sleep state. This feature allows the touch sensitive strip to augment or replace all physical buttons on the associated device.

9. Firmware in the hardware controller of claim 3 may modify touch activity to adjust for any prescribed minimum and maximum distances to accommodate the geometry of the mapped shape (e.g.: a touch on a curved segment may have different precision than a touch on a flat segment, etc.) (FIG. 7).

10. The firmware of claim 9 may interface with other controllers on the physical device to modify touch activity based on other input. For example, if a rectangular device is rotated clockwise from portrait to landscape orientation, the former “top” logical segment becomes the “right side” and the former “left side” becomes the “top.”

11. The firmware of claim 9 may ignore certain touch activities (such as a mass touch or lengthy touches) which are due to the device being held or coming into casual contact with the user (FIG. 8, FIG. 11).

12. The firmware of claim 9 evaluates cumulative touch activity and applies one or more heuristic(s) to determine one or more touches or gestures for the associated device. The associated device can then interpret these touches or gestures as commands applicable to the function and use of the device.
